(19) United States
(12) Patent Application Publication
(10) Pub. No.: US 2025/0159632 A1
(43) Pub. Date: May 15, 2025

(54) METHODS AND APPARATUSES FOR COMMUNICATING SYSTEM INFORMATION, AND READABLE STORAGE MEDIUMS

(71) Applicant: Beijing Xiaomi Mobile Software Co., Ltd., Beijing (CN)

(72) Inventor: Yajun ZHU, Beijing (CN)

(21) Appl. No.: 18/837,686

(22) PCT Filed: Feb. 14, 2022
(86) PCT No.: PCT/CN2022/076253

§ 371 Date: Aug. 12, 2024

(51) Int. Cl. H04W 56/00; H04L 5/00

(52) U.S. Cl. CPC H04W 56/0045; H04L 5/0048

(57) ABSTRACT

A method for receiving system information is performed by a user equipment, and includes: receiving updated system information; determining effective time for the updated system information; and starting to apply the updated system information at the effective time.

### CROSS REFERENCE TO RELATED APPLICATIONS

This application is a U.S. National Phase of International Application No. PCT/CN2022/076253, filed on Feb. 14, 2022, the entire content of which is incorporated herein by reference in its entirety.

### TECHNICAL FIELD

The present disclosure relates to the field of communication technologies, in particular to methods and apparatuses for communicating system information, and readable storage mediums.

### BACKGROUND

In the research of wireless communication technology, satellite communication is considered as an important aspect of the future development of wireless communication technology. The satellite communication refers to the communication that the radio communication device on the ground uses satellites as a relay. The satellite communication system includes a satellite part and a ground part. The characteristics of satellite communication are: wide communication range; as long as it is within the range covered by the radio waves emitted by the satellite, communication can be carried out between any two points; not susceptible to land disasters (high reliability). As a supplement to the current terrestrial cellular communication system, the satellite communication can have the following advantages. First, extended coverage is achieved. For areas that cannot be covered by the current cellular communication system or have high coverage costs, such as oceans, deserts and remote mountainous areas, the satellite communication can solve communication problems. Secondly, emergency communication can be carried out, for example, under the condition that the infrastructure of cellular communication is unavailable in the extreme case of disasters such as an earthquake, the satellite communication can be used to quickly establish a communication connection. In addition, it can also provide industrial applications, for example, for delay-sensitive services with long-distance transmission, the satellite communication can be used to reduce the delay of service transmission.

It can be predicted that in the future wireless communication system, the satellite communication system and the terrestrial cellular communication system will gradually achieve deep integration and truly realize Internet of Everything.

### SUMMARY

Embodiments of the present disclosure provides methods and apparatuses for communicating system information, and readable storage mediums.

According to a first aspect of the embodiments of the present disclosure, there is provided a method for receiving system information, performed by a user equipment, and including:
receiving updated system information;
determining effective time for the updated system information; and
starting to apply the updated system information at the effective time.

In some embodiments, the updated system information includes an updated cell-specific offset.

In some embodiments, the determining the effective time for the updated system information includes: receiving a high-level signaling transmitted by a network device, where the high-level signaling includes configuration information for indicating the effective time; and determining, based on the configuration information, the effective time for the updated system information, or
where the updated system information includes an updated cell-specific offset, and the determining the effective time for the updated system information and the starting to apply the updated system information at the effective time include: determining effective time for the updated cell-specific offset; and starting to apply the updated cell-specific offset at the effective time, where the determining effective time for the updated cell-specific offset includes: receiving a high-level signaling transmitted by a network device, where the high-level signaling includes configuration information for indicating the effective time; determining, based on the configuration information, the effective time for the updated cell-specific offset.

In some embodiments, the determining the effective time for the updated system information includes: determining, based on a predefined manner in a protocol, the effective time for the updated system information, or

where the updated system information includes an updated cell-specific offset, and the determining the effective time for the updated system information and the starting to apply the updated system information at the effective time include: determining effective time for the updated cell-specific offset; and starting to apply the updated cell-specific offset at the effective time, where the determining effective time for the updated cell-specific offset includes: determining, based on a predefined mode in a protocol, the effective time for the updated cell-specific offset.

In some embodiments, the effective time corresponds to an end position of a system information window in which the updated system information is located, or the effective time corresponds to an end position of a modification period for the system information.

In some embodiments, the method further includes: determining, based on the updated system information, that a conflict occurs in data transmission on a target transmission unit, and perform the data transmission based on a predefined rule, or
where the updated system information includes an updated cell-specific offset, and the method further includes: determining, based on the updated cell-specific offset, that a conflict occurs in data transmission on a target transmission unit; and performing the data transmission based on a predefined rule.

In some embodiments, the predefined rule includes:
abandoning the data transmission on the target transmission unit; or
selecting, for data transmission, a packet of a second value from a packet of a first value scheduled on the target transmission unit, where the second value is less than the first value.

According to a second aspect of the embodiments of the present disclosure, there is provided a method for transmitting system information, performed by a network device, and including:
transmitting updated system information to a user equipment;
where the updated system information is configured to cause the user equipment to determine effective time for the updated system information, and to start to apply the updated system information at the effective time.

In some embodiments, the updated system information includes an updated cell-specific offset.

In some embodiments, the method further includes: transmitting a high-level signaling to the user equipment, where the high-level signaling includes configuration information for indicating the effective time, and the effective time for the updated system information is determined based on the configuration information; or
where the updated system information includes an updated cell-specific offset, and the updated system information is configured to cause the user equipment to determine effective time for the updated cell-specific offset, and to start to apply the updated cell-specific offset at the effective time, where the method further includes: transmitting a high-level signaling to the user equipment, where the high-level signaling includes configuration information for indicating the effective time, and the effective time for the updated cell-specific offset is determined based on the configuration information.

In some embodiments, the effective time corresponds to an end position of a system information window in which the updated system information is located, or the effective time corresponds to an end position of a modification period for the system information.

According to a third aspect of the embodiments of the present disclosure, there is provided a communication device including a processor and a memory, where the memory is configured to store computer programs, and the computer programs, when executed by the processor, cause the processor to perform the method of the first aspect.

According to a fourth aspect of the embodiments of the present disclosure, there is provided a communication device including a processor and a memory, where the memory is configured to store computer programs, and the computer programs, when executed by the processor, cause the processor to perform the method of the second aspect.

According to a fifth aspect of the embodiments of the present disclosure, there is provided a computer-readable storage medium, storing instructions (or computer programs), where the instructions, when executed by a computer, cause the computer to perform the method of the first aspect.

According to a sixth aspect of the embodiments of the present disclosure, there is provided a computer-readable storage medium, storing instructions (or computer programs), where the instructions, when executed by a computer, cause the computer to perform the method of the second aspect.

It is to be understood that the above general descriptions and the below detailed descriptions are merely exemplary and explanatory, and are not intended to limit the present disclosure.

### BRIEF DESCRIPTION OF THE DRAWINGS

The drawings described here are used to provide a further understanding of the present specification and constitute a part of the present disclosure. The schematic implementations of the present disclosure and the description thereof are used to explain the present disclosure, and do not constitute an improper limitation on the present disclosure.

The accompanying drawings, which are incorporated in and constitute a part of this specification, illustrate embodiments consistent with the present disclosure and, together with the description, serve to explain the principles of the disclosure.

FIG. 1A is a schematic diagram illustrating a wireless communication system architecture according to an embodiment of the present disclosure.

FIG. 1B is a schematic diagram illustrating a mode for communicating system information according to an embodiment of the present disclosure.

FIG. 1C is a schematic diagram illustrating a mode for communicating system information according to another embodiment of the present disclosure.

FIG. 2 is a flowchart illustrating a method for communicating system information according to an embodiment of the present disclosure.

FIG. 3 is a flowchart illustrating a method for receiving system information according to an embodiment of the present disclosure.

FIG. 4 is a schematic structural diagram illustrating effective time according to an embodiment of the present disclosure.

FIG. 5 is a schematic structural diagram illustrating effective time according to another embodiment of the present disclosure.

FIG. 6 is a schematic structural diagram illustrating effective time according to yet another embodiment of the present disclosure.

FIG. 7 is a flowchart illustrating a method for receiving system information according to another embodiment of the present disclosure.

FIG. 8 is a schematic diagram illustrating a process for processing conflicting data according to an embodiment of the present disclosure.

FIG. 9 is a schematic diagram illustrating a process for processing conflicting data according to another embodiment of the present disclosure.

FIG. 10 is a flowchart illustrating a method for transmitting system information according to an embodiment of the present disclosure.

FIG. 11 is a flowchart illustrating a method for receiving system information according to yet another embodiment of the present disclosure.

FIG. 12 is a flowchart illustrating a method for receiving system information according to still another embodiment of the present disclosure.

FIG. 13 is a flowchart illustrating a method for transmitting system information according to another embodiment of the present disclosure.

FIG. 14 is a flowchart illustrating an apparatus for transmitting system information according to an embodiment of the present disclosure.

FIG. 15 is a flowchart illustrating a device for transmitting system information according to an embodiment of the present disclosure.

FIG. 16 is a flowchart illustrating an apparatus for receiving system information according to an embodiment of the present disclosure.

FIG. 17 is a flowchart illustrating a device for receiving system information according to an embodiment of the present disclosure.

### DETAILED DESCRIPTION OF THE EMBODIMENTS

The embodiments of the present disclosure will be further described in detail below in conjunction with accompanying drawings and specific examples.

Examples will be described in detail herein, with the illustrations thereof represented in the drawings. Where the following description relates to the drawings, unless otherwise indicated, the same numerals in different drawings represent the same or similar elements. The embodiments described in the following exemplary embodiments do not represent all embodiments consistent with the present disclosure. Rather, they are merely examples of apparatuses and methods consistent with some aspects of the present disclosure as detailed in the appended claims.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

Hereinafter, the embodiments of the present disclosure will be described in detail, examples of which are illustrated in the accompanying drawings, where the same or similar reference numerals indicate the same or similar elements throughout. The embodiments described below by reference to the accompanying drawings are exemplary and are intended to explain the present disclosure and are not to be construed as limiting the present disclosure.

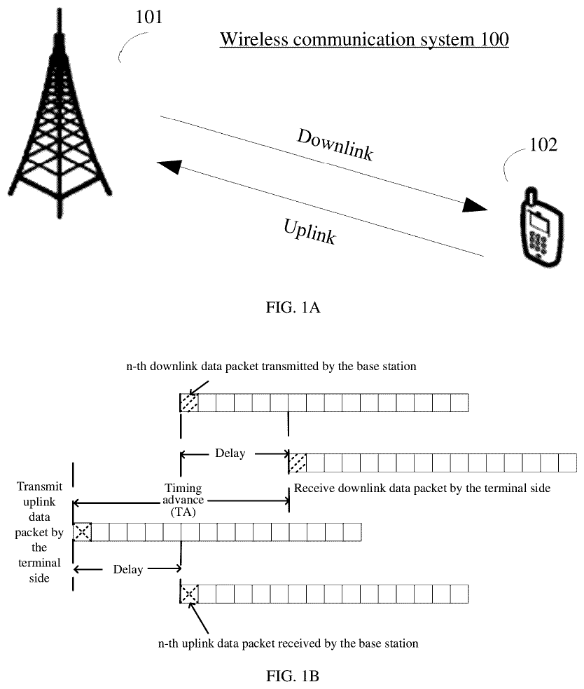

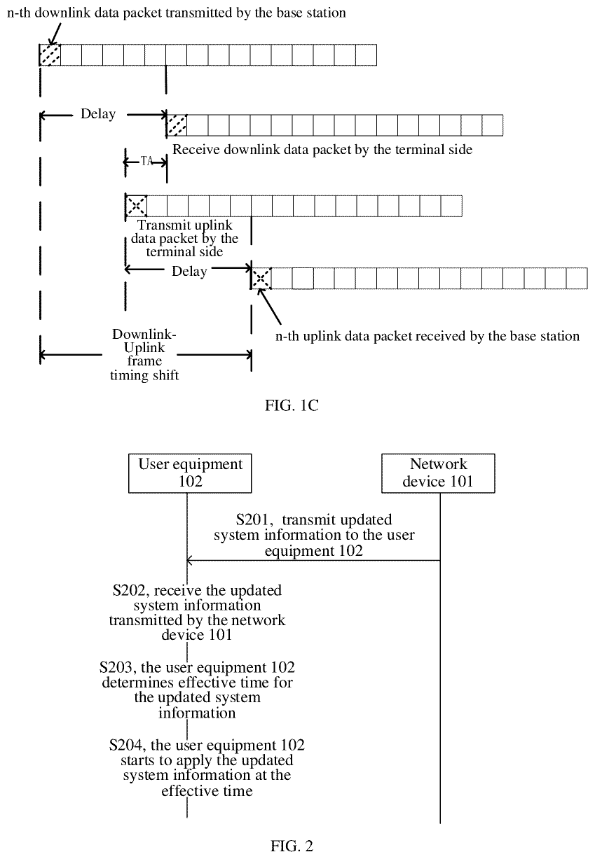

As shown in FIG. 1A, an embodiment of the present disclosure provides a method for communicating system information that can be applied to a wireless communication system 100, which may include, but is not limited to, a network device 101 and a user equipment 102. The user equipment 102 is configured to support carrier aggregation, and the user equipment 102 may be connected to a plurality of carrier units of the network device 101, including a primary component carrier unit and one or more secondary component carrier units.

It will be understood that the wireless communication system 100 may be suitable for both low frequency and high frequency scenes. The application scenes of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) systems, a future 5th-generation (5G) system, a new radio (NR) communication system, a future evolved public land mobile network (PLMN) system, and other systems.

The user equipment 102 may be a user equipment (UE), a terminal, an access terminal, a terminal unit, a terminal station, a mobile station (MS), a remote station, a remote terminal, a mobile terminal, a wireless communication device, a terminal agent, etc. The user equipment 102 may have a wireless transmitting and receiving function, which is capable of communicating (e.g., wireless communication) with one or more network devices 101 of one or more communication systems and accepting network services provided by the network devices 101, which herein include, but are not limited to, a base station illustrated.

The user equipment 102 may be a cellular telephone, a cordless telephone, a session initiation protocol (SIP) telephone, a wireless local loop (WLL) station, a personal digital assistant (PDA) device, a handheld device with wireless communication capabilities, a computing device, other processing devices connected to wireless modems, an on-board device, a wearable device, a user equipment in a future 5G network or in a future evolved PLMN network, and so on.

The network device 101 may be an access network device (or access network station). The access network device is a device that has the function of providing network access, such as a radio access network (RAN) base station and the like. The network device may include a base station (BS) device, or include a BS device and a wireless resource management device for controlling the BS device, and the like. The network device may also include relay stations (relay devices), access points, and base stations in the future 5G network, and base stations or NR base stations in the future evolved PLMN network, and the like. The network device may be a wearable device or an on-board device. The network device can also be a communication chip with a communication module.

For example, the network device 101 includes, but is not limited to, a next-generation base station (gnodeB, gNB) in 5G, an evolved node B (eNB) in an LTE system, a radio network controller (RNC), a node B (NB) in a wideband code division multiple access (WCDMA) system, a wireless controller in a centralized radio access network (CRAN) system, a base station controllers (BSC), a base transceiver station (BTS) in a global system for mobile communication (GSM) or code division multiple access (CDMA) system, and a home base stations (e.g, home evolved node B, or home node B (HNB)), a baseband unit (BBU), a transmitting and receiving point (TRP), a transmitting point (TP), or a mobile switching center.

Before describing the scheme for transmitting system information provided by the present disclosure, the manner in which timing adjustments are performed is described.

In a first mode, there is a long signal transmission distance between the transmitter and the receiver, as a result, the data transmission time is long. For the transmission with uplink and downlink relationship, in the relevant standardization, the parameters of Koffset can be introduced to compensate for transmission delay.

In a second mode, timing advance (TA) can be used to let the terminal transmit the data packet in advance.

Referring to FIG. 1B, the downlink data packet transmitted by the base station on the n-th downlink transmission unit reaches the terminal side downlink transmission unit after a certain transmission delay, and the uplink data packet transmitted by the terminal side on the n-th uplink transmission unit has a specified TA value relative to the downlink data packet received at the n-th downlink transmission unit, so that the base station side can realize uplink and downlink timing alignment.

Alternatively, as shown in FIG. 1C, the uplink and downlink timing on the base station side may not be aligned, and there is a specified frame timing shift between the n-th downlink transmission unit and the n-th uplink transmission unit on the base station side.

However, in the scene of satellite communication, there is a long signal transmission distance between the transmitter and the receiver, as a result, the data transmission time is long. For the transmission with uplink (UL) and downlink (DL) relationship, Koffset can be introduced to compensate for transmission delay. At least cell-specific Koffset and user equipment (UE)-specific Koffset are supported. The cell-specific Koffset is notified through the system information block (SIB), and with the movement of the satellite, the cell-specific Koffset may be updated. When the system information is updated, the time when the user equipment receives the system information in the system information modification period is not limited. As a result, in the scene of non-terrestrial networks (NTN), there may be a period of ambiguity, during which there may be a conflict in the transmission of user equipment.

An embodiment of the present disclosure provides a method for communicating system information. FIG. 2 is a flowchart illustrating a method for communicating system information according to the embodiment of the present disclosure. As shown in FIG. 2, the method includes the following steps S201 to S204.

At step S201, the network device 101 transmits updated system information to the user equipment 102.

At step S202, the user equipment 102 receives the updated system information transmitted by the network device 101.

At step S203, the user equipment 102 determines effective time for the updated system information.

At step S204, the user equipment 102 starts to apply the updated system information at the effective time.

In some embodiments, the updated system information includes an updated cell-specific Koffset.

In the embodiments of the present disclosure, the network device transmits the updated system information to the user equipment, and the user equipment receives the updated system information, determines the effective time for the updated system information, and starts to apply the updated system information at the effective time, so that the user equipment and the network device have a consistent understanding of the effective time for the updated system information, a conflict in data transmission of the user equipment is prevented, and effective data transmission between the user equipment and the network device is ensured.

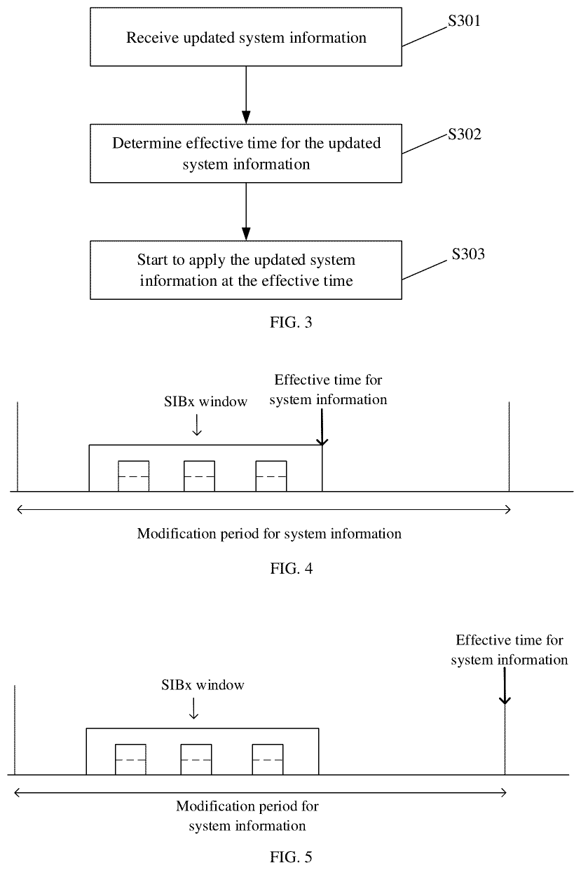

The embodiments of the present disclosure provide a method for transmitting system information, performed by the user equipment, which may be performed independently or in combination with any of the other embodiments of the present disclosure. FIG. 3 is a flowchart illustrating the method for receiving system information according to the embodiment of the present disclosure. As shown in FIG. 3, the method includes the following steps S301 to S303.

At step S301, updated system information is received.

At step S302, effective time for the updated system information is determined.

At step S303, the updated system information is started to be applied at the effective time.

In some embodiments, the updated system information includes an updated cell-specific offset. In some embodiments, the updated cell-specific offset is an updated cell-specific Koffset.

In some embodiments, the method further includes: receiving a high-level signaling transmitted by a network device, where the high-level signaling includes configuration information for indicating the effective time. In step S302, the determining the effective time for the updated system information includes: determining, based on the configuration information, the effective time for the updated system information.

In some embodiments, in step S302, the determining the effective time for the updated system information includes: determining, based on a predefined manner in a protocol, the effective time for the updated system information.

In some embodiments, as shown in FIG. 4, the effective time corresponds to an end position of a system information (system information block (SIB)x) window in which the updated system information is located.

In some embodiments, as shown in FIG. 5, the effective time corresponds to an end position of a modification period for the system information. In some embodiments, the modification period for the system information is periodic, and each modification period for the system information may correspond to a system information modification cycle.

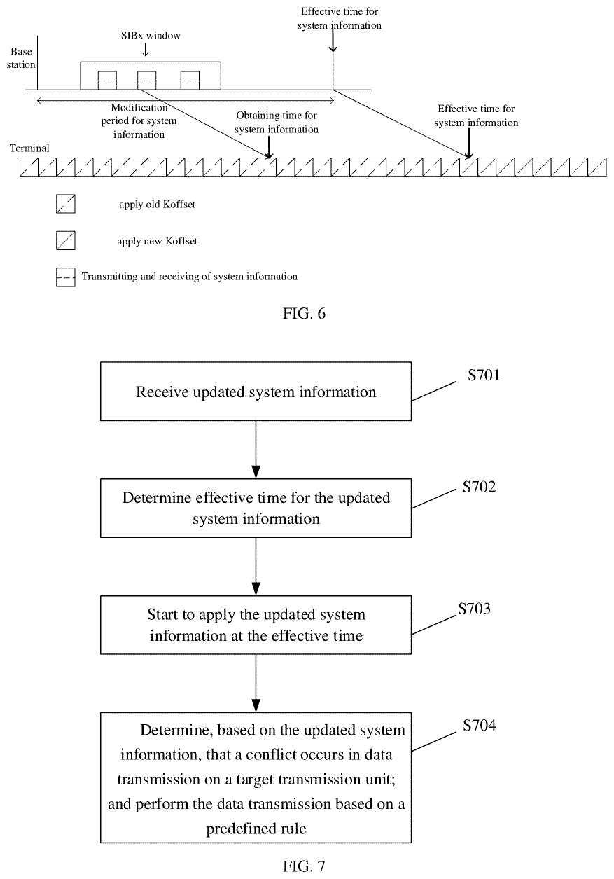

In some embodiments, as shown in FIG. 6, the user equipment uses a cell-specific Koffset transmitted in an old system information before the effective time for the updated system information, where the old system information is the previous system information of the updated system information or is referred to as the historical system information received at the most recent reception moment from the reception of the updated system information.

In some embodiments, as shown in FIG. 6, the new (updated) cell-specific Koffset transmitted in the updated system information is started to be applied at the effective time.

In the embodiments of the present disclosure, the user equipment receives the updated system information, determines the effective time for the updated system information, and starts to apply the updated system information at the effective time, so that the user equipment and the network device have a consistent understanding of the effective time for the updated system information, a conflict in data transmission of the user equipment is prevented, and effective data transmission between the user equipment and the network device is ensured.

The embodiments of the present disclosure provide a method for receiving system information, performed by the user equipment, which may be performed independently or in combination with any of the other embodiments of the present disclosure. FIG. 7 is a flowchart illustrating a method for receiving system information according to another embodiment of the present disclosure. As shown in FIG. 7, the method includes the following steps S701 to S704.

At step S701, updated system information is received.

At step S702, effective time for the updated system information is determined.

At step S703, the updated system information is applied at the effective time.

At step S703, based on the updated system information, it is determined that a conflict occurs in data transmission on a target transmission unit, and the data transmission is performed based on a predefined rule.

In some embodiments, the updated system information includes an updated cell-specific offset. In some embodiments, the updated cell-specific offset is an updated cell-specific Koffset.

In some embodiments, the method further includes: receiving a high-level signaling transmitted by a network device, where the high-level signaling includes configuration information for indicating the effective time. In step S302, the determining the effective time for the updated system information includes: determining, based on the configuration information, the effective time for the updated system information.

In some embodiments, the determining the effective time for the updated system information includes:
determining, based on a predefined manner in a protocol, the effective time for the updated system information.

In some embodiments, the effective time corresponds to an end position of a system information window in which the updated system information is located.

In some embodiments, the effective time corresponds to an end position of a modification period for the system information.

In some embodiments, the transmission unit may be a slot, a half-slot, a sub-frame, a radio-frame or a symbol in a time domain.

In some embodiments, the predefined rule includes: abandoning the data transmission on the target transmission unit.

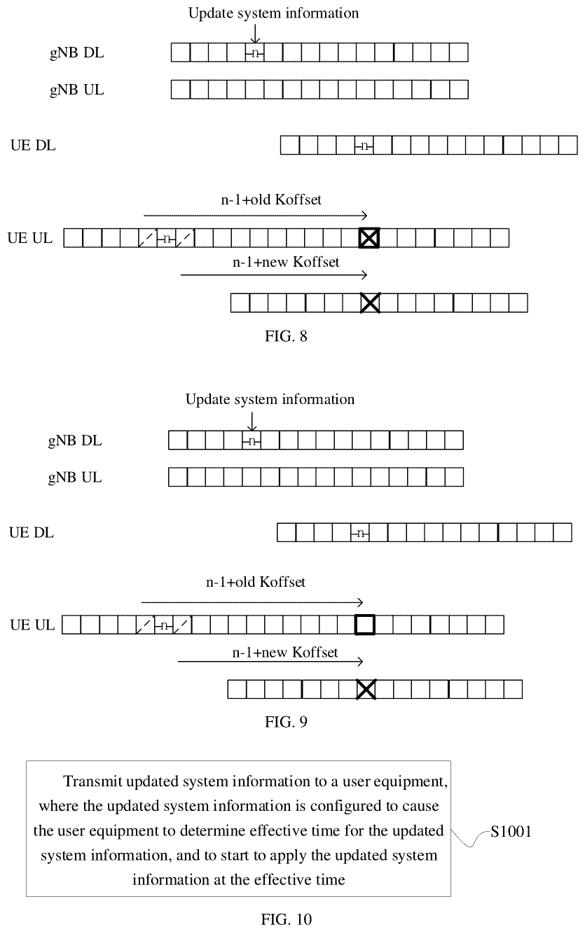

In an embodiment, as shown in FIG. 8, in the event of a collision in the uplink data transmission scheduled by the terminal on slots n−1 and n+1, the terminal abandons scheduling data on the slots n−1 and n+1.

In some embodiments, a packet of a second value from a packet of a first value scheduled on the target transmission unit is selected for data transmission, where the second value is less than the first value.

In an embodiment, as shown in FIG. 9, in the event of a collision in the uplink data transmission scheduled by the terminal on slots n−1 and n+1, the terminal abandons scheduling data on the slot n+1 and schedules data on the slot n−1 only.

In another embodiment, in the event of a collision in the uplink data transmission scheduled by the terminal on slots n−1 and n+1, the terminal abandons scheduling data on the slot n−1 and schedules data on the slot n+1 only.

In an embodiment of the present disclosure, the user equipment receives the updated system information, determines the effective time for the updated system information, and starts to apply the updated system information at the effective time. Also, based on the updated system information it is determined that in case of a conflict of data transmission on the target transmission unit, the user equipment performs the data transmission based on the predefined rule, so that a conflict in data transmission on the target transmission unit is prevented, and effective data transmission is ensured.

The embodiments of the present disclosure provide a method for transmitting system information, performed by a network device, which may be performed independently or in combination with any of the other embodiments of the present disclosure. FIG. 10 is a flowchart illustrating a method for transmitting system information according to an embodiment of the present disclosure. As shown in FIG. 10, the method includes the following step S1001.

At step S1001, updated system information is transmitted to the user equipment, where the updated system information is configured to cause the user equipment to determine effective time for the updated system information, and to start to apply the updated system information at the effective time.

In some embodiments, the updated system information includes an updated cell-specific offset. In some embodiments, the updated cell-specific offset is an updated cell-specific Koffset.

In some embodiments, the method further includes: transmitting a high-level signaling to user equipment, where the high-level signaling includes configuration information for indicating the effective time.
the determining the effective time for the updated system information includes: determining, based on the configuration information, the effective time for the updated system information.

In some embodiments, the effective time corresponds to an end position of a system information window in which the updated system information is located.

In some embodiments, the effective time corresponds to an end position of a modification period for the system information.

In the embodiments of the present disclosure, the network device transmits the updated system information to the user equipment, where the updated system information is configured to cause the user equipment to determine effective time for the updated system information, and to start to apply the updated system information at the effective time, so that the user equipment and the network device have a consistent understanding of the updated system information, a conflict in data transmission of the user equipment is prevented, and effective data transmission is ensured.

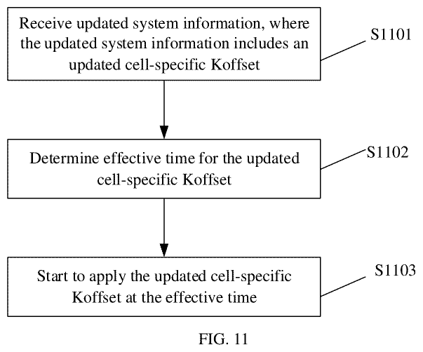

The embodiments of the present disclosure provide a method for receiving system information, performed by the user equipment, which may be performed independently or in combination with any of the other embodiments of the present disclosure. FIG. 11 is a flowchart illustrating a method for receiving system information according to an embodiment of the present disclosure. As shown in FIG. 11, the method includes the following steps S1101 to S1103.

At step S1101, updated system information is received, where the updated system information includes an updated cell-specific offset (Koffset).

At step S1102, effective time for the updated cell-specific offset is determined.

At step S1103, the updated cell-specific offset is started to be applied at the effective time.

In some embodiments, the updated cell-specific offset is an updated cell-specific Koffset.

In some embodiments, the method further includes: receiving a high-level signaling transmitted by a network device, where the high-level signaling includes configuration information for indicating the effective time.

In step S1102, the determining the effective time for the updated cell-specific offset includes: determining, based on the configuration information, the effective time for the updated cell-specific offset.

In some embodiments, in step S1102, the determining the effective time for the updated cell-specific offset includes:
determining, based on a predefined manner in a protocol, the effective time for the updated cell-specific offset.

In some embodiments, in step S1103, the effective time corresponds to an end position of a system information window in which the updated system information is located, or the effective time corresponds to an end position of a modification period for the system information.

Some embodiments further include step S1104: determining, based on the updated cell-specific offset (Koffset), that a conflict occurs in data transmission on a target transmission unit, and perform the data transmission based on a predefined rule.

In the embodiments of the present disclosure, the user equipment receives the updated system information transmitted by the network device, where the updated system information includes the cell-specific offset (Koffset). The user equipment determines the effective time for the updated cell-specific offset (Koffset), and starts to apply the updated cell-specific offset (Koffset) at the effective time, so that the user equipment and the network device have a consistent understanding of the effective time for the updated cell-specific offset (Koffset), a conflict in data transmission of the user equipment is prevented, and effective data transmission of the user equipment is ensured.

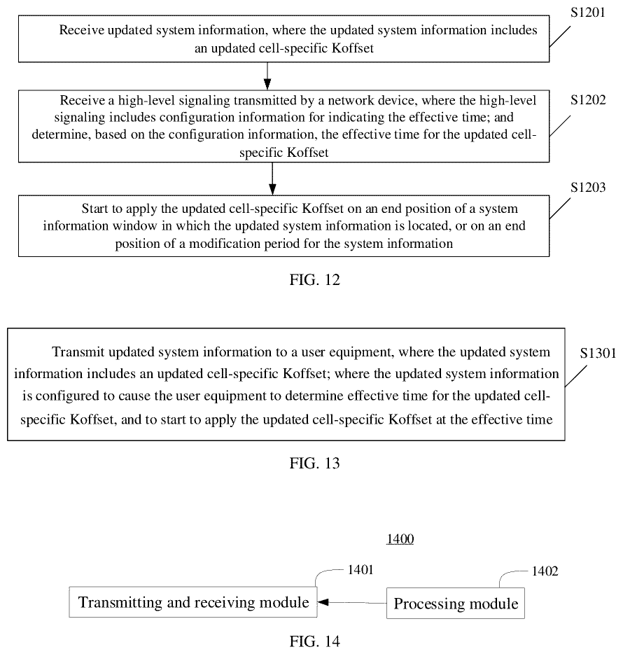

The embodiments of the present disclosure provide a method for receiving system information, performed by the user equipment, which may be performed independently or in combination with any of the other embodiments of the present disclosure. FIG. 12 is a flowchart illustrating a method for receiving system information according to an embodiment of the present disclosure. As shown in FIG. 12, the method includes the following step S1201 to S1203.

At step S1201, updated system information is received, where the updated system information includes an updated cell-specific offset (Koffset).

At step S1202, a high-level signaling transmitted by a network device is received, where the high-level signaling includes configuration information for indicating the effective time; and based on the configuration information, the effective time for the updated cell-specific offset is determined.

At step S1203, the updated cell-specific offset is started to be applied on an end position of a system information window in which the updated system information is located, or on an end position of a modification period for the system information.

In some embodiments, the updated cell-specific offset is an updated cell-specific Koffset.

In the embodiments of the present disclosure, the user equipment receives the updated system information transmitted by the network device, where the updated system information includes the cell-specific offset (Koffset). The user equipment receives the high-level signaling transmitted by the network device including the configuration information for indicating the effective time to determine the effective time for the updated cell-specific offset (Koffset), and starts to apply the updated cell-specific offset (Koffset) at the effective time, so that the user equipment and the network device have a consistent understanding of the effective time for the updated cell-specific offset (Koffset). Also, based on the updated system information it is determined that in case of a conflict of data transmission on the target transmission unit, the user equipment performs the data transmission based on the predefined rule, so that a conflict in data transmission on the target transmission unit is prevented, and effective data transmission is ensured.

The embodiments of the present disclosure provide a method for receiving system information, performed by the user equipment, which may be performed independently or in combination with any of the other embodiments of the present disclosure. The method includes:
receiving updated system information, where the updated system information includes an updated cell-specific offset (Koffset);
determining effective time for the updated cell-specific offset; and
starting to apply the updated cell-specific offset at the effective time.

Based on the updated system information, it is determined that a conflict occurs in data transmission on a target transmission unit, and the data transmission is performed based on a predefined rule.

In some embodiments, the updated cell-specific offset is an updated cell-specific Koffset.

In some embodiments, the transmission unit may be a slot, a half-slot, a sub-frame, a radio-frame or a symbol in a time domain.

In some embodiments, the predefined rule includes: abandoning the data transmission on the target transmission unit.

In an embodiment, as shown in FIG. 8, in the event of a collision in the uplink data transmission scheduled by the terminal on slots n−1 and n+1, the terminal abandons scheduling data on the slots n−1 and n+1.

In some embodiments, a packet of a second value from a packet of a first value scheduled on the target transmission unit is selected for data transmission, where the second value is less than the first value.

In an embodiment, as shown in FIG. 9, in the event of a collision in the uplink data transmission scheduled by the terminal on slots n−1 and n+1, the terminal abandons scheduling data on the slot n−1 and schedules data on the slot n−1 only.

In another embodiment, in the event of a collision in the uplink data transmission scheduled by the terminal on slots n−1 and n+1, the terminal abandons scheduling data on the slot n−1 and schedules data on the slot n+1 only.

In the embodiments of the present disclosure, the user equipment receives the updated system information transmitted by the network device, where the updated system information includes the cell-specific offset (Koffset). The user equipment determines the effective time for the updated cell-specific offset (Koffset), and starts to apply the updated cell-specific offset (Koffset) at the effective time. Also, based on the updated system information it is determined that in case of a conflict of data transmission on the target transmission unit, the user equipment performs the data transmission based on the predefined rule, so that a conflict in data transmission on the target transmission unit is prevented, and effective data transmission is ensured.

The embodiments of the present disclosure provide a method for transmitting system information, performed by a network device, which may be performed independently or in combination with any of the other embodiments of the present disclosure. FIG. 13 is a flowchart illustrating a method for transmitting system information according to an embodiment of the present disclosure. As shown in FIG. 13, the method includes the following step S1301.

At step S1301, updated system information is transmitted to the user equipment where the updated system information is configured to cause the user equipment to determine effective time for the updated cell-specific offset (Koffset), and to start to apply the updated cell-specific offset at the effective time.

In some embodiments, the method further includes:
transmitting a high-level signaling to the user equipment, where the high-level signaling includes configuration information for indicating the effective time.

The determining effective time for the updated cell-specific offset (Koffset) includes:
based on the configuration information, determining the effective time for the updated cell-specific offset (Koffset).

In some embodiments, the effective time corresponds to an end position of a system information window in which the updated system information is located.

In some embodiments, the effective time corresponds to an end position of a modification period for the system information.

In the embodiments of the present disclosure, the network device transmits the updated system information to the user equipment, where the updated system information includes the cell-specific offset (Koffset). The updated system information is configured to cause the user equipment to determine the effective time for the updated cell-specific offset (Koffset), and the user equipment starts to apply the updated cell-specific offset (Koffset) at the effective time, so that the user equipment and the network device have a consistent understanding of the effective time for the updated cell-specific offset (Koffset), a conflict in data transmission of the user equipment on the target transmission unit is prevented, and effective data transmission is ensured.

Based on the same conception as the method embodiments, embodiments of the present disclosure further provide a communication device that may have the functions of the user equipment 102 in the method embodiments and be used to perform the steps provided in the above-mentioned embodiments and performed by the user equipment 102. The functions may be implemented by software, or by hardware executing corresponding software. The hardware or software includes one or more modules corresponding to the above-mentioned functions.

In an embodiment, the communication apparatus 1400 as shown in FIG. 14 may serve as the user equipment 102 involved in the method embodiments and perform the steps performed by the user equipment 102 in the method embodiments.

The apparatus 1400 includes a transmitting and receiving module 1401, and a processing module 1402.

Corresponding to the conception of the first method embodiment:
the transmitting and receiving module 1401 is configured to receive updated system information; and
the processing module 1402 is configured to determine effective time for the updated system information, and to start to apply the updated system information at the effective time.

In some embodiments, the updated system information includes an updated cell-specific offset (Koffset).

In some embodiments, the updated cell-specific offset is an updated cell-specific Koffset.

In some embodiments, the transmitting and receiving module 1401 is further configured to receive a high-level signaling transmitted by a network device, where the high-level signaling includes configuration information for indicating the effective time; and
the processing module 1402 is further configured to determine, based on the configuration information, the effective time for the updated system information.

In some embodiments, the processing module 1402 is further configured to determine, based on a predefined manner in a protocol, the effective time for the updated system information.

In some embodiments, the effective time corresponds to an end position of a system information window in which the updated system information is located, or the effective time corresponds to an end position of a modification period for the system information.

In some embodiments, the processing module 1402 is further configured to determine, based on the updated system information, that a conflict occurs in data transmission on a target transmission unit, and perform the data transmission based on a predefined rule.

In some embodiments, the predefined rule includes:
abandoning the data transmission on the target transmission unit; or
selecting, for data transmission, a packet of the second value from a packet of a first value scheduled on the target transmission unit, where the second value is less than the first value.

Corresponding to the conception of the second method embodiment:
the transmitting and receiving module 1401 is configured to receive updated system information, where the updated system information includes an updated cell-specific offset (Koffset); and
the processing module 1402 is configured to determine effective time for the updated cell-specific offset, and to start to apply the updated cell-specific offset at the effective time.

In some embodiments, the updated cell-specific offset is an updated cell-specific Koffset.

In some embodiments, the transmitting and receiving module 1401 is further configured to receive a high-level signaling transmitted by a network device, where the high-level signaling includes configuration information for indicating the effective time; and
the processing module 1402 is further configured to, based on the configuration information, determine the effective time for the updated cell-specific offset.

In some embodiments, the processing module 1402 is further configured to determine, based on a predefined manner in a protocol, the effective time for the updated cell-specific offset (Koffset).

In some embodiments, the effective time corresponds to an end position of a system information window in which the updated system information is located, or the effective time corresponds to an end position of a modification period for the system information.

In some embodiments, the processing module 1402 is further configured to determine, based on the updated cell-specific offset, that a conflict occurs in data transmission on a target transmission unit, and perform the data transmission based on a predefined rule.

In some embodiments, the predefined rule includes:
abandoning the data transmission on the target transmission unit; or
selecting, for data transmission, a packet of the second value from a packet of a first value scheduled on the target transmission unit, where the second value is less than the first value.

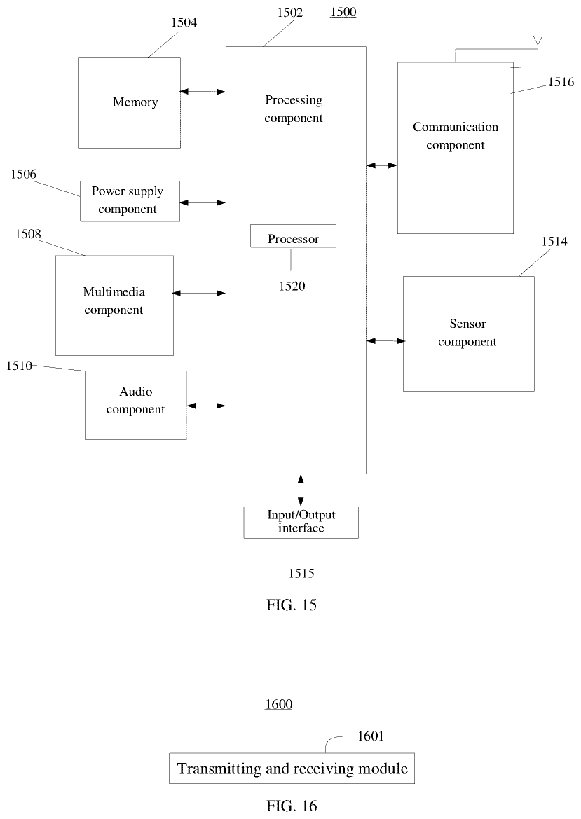

FIG. 15 is a flowchart illustrating a device for transmitting system information according to another embodiment of the present disclosure. For example, the device 1500 can be a mobile phone, a computer, a digital broadcast terminal, a message transmitting and receiving device, a gaming console, a tablet device, a medical device, a fitness device, a personal digital assistant, and the like.

Referring to FIG. 15, the device 1500 can include one or more of the following components: a processing component 1502, a memory 1504, a power supply component 1506, a multimedia component 1508, an audio component 1510, an input/output (I/O) interface 1515, a sensor component 1514, and a communication component 1516.

The processing component 1502 usually controls overall operations of the device 1500, such as operations related to display, a telephone call, data communication, a camera operation and a record operation. The processing component 1502 may include one or more processors 1520 to execute instructions to complete all or a part of the steps of the above methods. Further, the processing component 1502 may include one or more modules to facilitate interaction between the processing component 1502 and another component. For example, the processing component 1502 may include a multimedia module to facilitate the interaction between the multimedia component 1508 and the processing component 1502.

The memory 1504 is configured to store different types of data to support operations at the device 1500. Examples of such data include instructions, contact data, phone book data, messages, pictures, videos, and so on for any application or method that operates on the device 1500. The memory 1504 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or optical disk.

The power supply component 1506 supplies power for different components of the device 1500. The power supply component 1506 may include a power supply management system, one or more power supplies, and other components associated with generating, managing and distributing power for the device 1500.

The multimedia component 1508 includes a screen for providing an output interface between the device 1500 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 1508 may include a front camera and/or a rear camera. When the device 1500 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 1510 is configured to output and/or input an audio signal. For example, the audio component 1510 may include a microphone (MIC). When the device 1500 is in an operating mode, such as a call mode, a recording mode and a speech recognition mode, the microphone is configured to receive an external audio signal. The received audio signal may be further stored in the memory 1504 or sent via the communication component 1516. In some embodiments, the audio component 1510 also includes a speaker for outputting an audio signal.

The I/O interface 1515 may provide an interface between the processing component 1502 and peripheral interface modules. The above peripheral interface modules may include a keyboard, a click wheel, buttons and so on. Such buttons may include but not limited to: a home button, a volume button, a start button and a lock button.

The sensor component 1514 includes one or more sensors for providing state assessments in different aspects for the device 1500. For example, the sensor component 1514 may detect an on/off state of the device 1500 and a relative location of components. For example, the components are a display and a keypad of the device 1500. The sensor component 1514 may also detect a position change of the device 1500 or a component of the device 1500, presence or absence of a touch of a user on the device 1500, an orientation or acceleration/deceleration of the device 1500, and a temperature change of the device 1500. The sensor component 1514 may include a proximity sensor configured to detect presence of a nearby object without any physical contact. The sensor component 1514 may also include an optical sensor, such as a CMOS or CCD image sensor used in an imaging application. In some embodiments, the sensor component 1514 may also include an acceleration sensor, a gyroscope sensor, a magnetic sensor, a pressure sensor, or a temperature sensor.

The communication component 1516 is configured to facilitate wired or wireless communication between the device 1500 and other devices. The device 1500 may access a wireless network based on a communication standard, such as WiFi, 4G or 5G, or a combination thereof. In some embodiments, the communication component 1516 may receive a broadcast signal or broadcast-related information from an external broadcast management system via a broadcast channel. In an example, the communication component 1516 may also include a near field communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology and other technologies.

In an example, the device 1500 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method in any one of the above examples.

In an example, a non-transitory computer readable storage medium including instructions, such as the memory 1504 including instructions, is also provided. The above instructions may be executed by the processor 1520 of the device 1500 to complete the above method. For example, the non-transitory computer readable storage medium may be a read-only memory (ROM), a random access memory (RAM), a CD-ROM, a magnetic tape, a floppy disk and an optical data storage device, etc.

Based on the same conception as the method embodiments, embodiments of the present disclosure further provide a communication device that may have the functions of the network device 101 in the method embodiments and be used to perform the steps provided in the above-mentioned embodiments and performed by the network device 101. The functions may be implemented by software, or by hardware executing corresponding software. The hardware or software includes one or more modules corresponding to the above-mentioned functions.

In an embodiment, the communication apparatus 1600 as shown in FIG. 16 may serve as the network device 101 involved in the method embodiments and perform the steps performed by the network device 101 in the method embodiments.

The apparatus 1600 includes a transmitting and receiving module 1601.

Corresponding to the conception of the first method embodiment:
the transmitting and receiving module 1601 is configured to transmit updated system information to a user equipment;
where the updated system information is configured to cause the user equipment to determine effective time for the updated system information, and to start to apply the updated system information at the effective time.

In some embodiments, the updated system information includes an updated cell-specific offset (Koffset).

In some embodiments, the updated cell-specific offset is an updated cell-specific Koffset.

In some embodiments, the transmitting and receiving module 1601 is further configured to transmit a high-level signaling to the user equipment, where the high-level signaling includes configuration information for indicating the effective time; and
where the determining the effective time for the updated system information includes:
determining, based on the configuration information, the effective time for the updated system information.

In some embodiments, the effective time corresponds to an end position of a system information window in which the updated system information is located, or the effective time corresponds to an end position of a modification period for the system information.

Corresponding to the conception of the second method embodiment:
the transmitting and receiving module 1601 is configured to transmit updated system information to a user equipment, where the updated system information includes an updated cell-specific offset (Koffset);
where the updated system information is configured to cause the user equipment to determine effective time for the updated cell-specific offset, and to start to apply the updated cell-specific offset at the effective time.

In some embodiments, the updated cell-specific offset is an updated cell-specific Koffset.

In some embodiments, the transmitting and receiving module 1601 is further configured to transmit a high-level signaling to the user equipment, where the high-level signaling includes configuration information for indicating the effective time.

The determining effective time for the updated cell-specific offset includes:
based on the configuration information, determining the effective time for the updated cell-specific offset (Koffset).

In some embodiments, the effective time corresponds to an end position of a system information window in which the updated system information is located, or the effective time corresponds to an end position of a modification period for the system information.

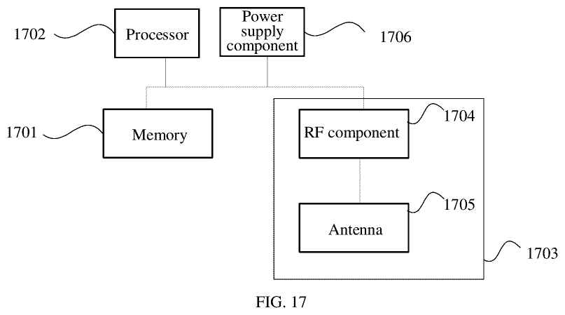

When a communication device is a network device, its structure may also be shown in FIG. 17. The structure of the communication device is illustrated by the example of the network device 101. As shown in FIG. 17, the communication device 1700 includes a memory 1701, a processor 1702, a transmitting and receiving component 1703, and a power supply component 1706. The memory 1701 is coupled to the processor 1702 and may be configured to store programs and data necessary for the communication device 1700 to implement various functions. The processor 1702 is configured to support the communication device 1700 to perform the corresponding function in the above-mentioned methods, which can be realized by calling the programs stored in the memory 1701. The transmitting and receiving component 1703 may be a wireless transceiver that may be used to support the communication device 1700 to receive signaling and/or data through a radio Interface, as well as to transmit signaling and/or data. The transmitting and receiving component 1703 may also be referred to as a transmitting and receiving unit or a communication unit, and the transmitting and receiving component 1703 may include an radio frequency (RF) component 1704 and one or more antennas 1705, where the RF component 1704 may be a remote radio unit (RRU), which may be specifically used for transmission of RF signals and conversion of RF signals to baseband signals, and the one or more antennas 1705 may be specifically used to perform radiation and reception of RF signals.

When the communication device 1700 needs to transmit data, the processor 1702 can perform baseband processing on the data to be transmitted, and then output a baseband signal to the radio frequency unit, and the radio frequency unit performs radio frequency processing on the baseband signal and then transmits the radio frequency signal in the form of electromagnetic waves through the antenna. When there is data transmitted to the communication device 1700, the radio frequency unit receives the radio frequency signal through the antenna, converts the radio frequency signal to a baseband signal, and outputs the baseband signal to the processor 1702, and the processor 1702 converts the baseband signal to data and processes the data.

After considering the specification and practicing the present disclosure, those skilled in the art would easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the present disclosure is to be limited only by the appended claims.

### Industrial Application

In the embodiments of the present disclosure, the user equipment receives the updated system information, determines the effective time for the updated system information, and starts to apply the updated system information at the effective time, so that the user equipment and the network device have a consistent understanding of the effective time for the updated system information, and effective data transmission between the user equipment and the network device is ensured.

1. A method for receiving system information, performed by a user equipment, and comprising:
receiving updated system information;
determining effective time for the updated system information; and
starting to apply the updated system information at the effective time.

2. The method of claim 1, wherein the updated system information comprises an updated cell-specific offset.

3. The method of claim 1, wherein the determining the effective time for the updated system information comprises: receiving a high-level signaling transmitted by a network device, wherein the high-level signaling comprises configuration information for indicating the effective time; and determining, based on the configuration information, the effective time for the updated system information; or
wherein the updated system information comprises an updated cell-specific offset, and the determining the effective time for the updated system information and the starting to apply the updated system information at the effective time comprise: determining effective time for the updated cell-specific offset; and starting to apply the updated cell-specific offset at the effective time, wherein the determining effective time for the updated cell-specific offset comprises: receiving a high-level signaling transmitted by a network device, wherein the high-level signaling comprises configuration information for indicating the effective time; determining, based on the configuration information, the effective time for the updated cell-specific offset.

4. The method of claim 1, wherein the determining the effective time for the updated system information comprises: determining, based on a predefined mode in a protocol, the effective time for the updated system information; or
wherein the updated system information comprises an updated cell-specific offset, and the determining the effective time for the updated system information and the starting to apply the updated system information at the effective time comprise: determining effective time for the updated cell-specific offset; and starting to apply the updated cell-specific offset at the effective time, wherein the determining effective time for the updated cell-specific offset comprises: determining, based on a predefined mode in a protocol, the effective time for the updated cell-specific offset.

5. The method of claim 1, wherein
the effective time corresponds to an end position of a system information window in which the updated system information is located, or
the effective time corresponds to an end position of a modification period for the system information.

6. The method of claim 1, wherein the method further comprises: determining, based on the updated system information, that a conflict occurs in data transmission on a target transmission unit; and performing the data transmission based on a predefined rule; or
wherein the updated system information comprises an updated cell-specific offset, and the method further comprises: determining, based on the updated cell-specific offset, that a conflict occurs in data transmission on a target transmission unit; and performing the data transmission based on a predefined rule.

7. The method of claim 6, wherein the predefined rule comprises:
abandoning the data transmission on the target transmission unit; or
selecting, for data transmission, a data packet of a second value from a data packet of a first value scheduled on the target transmission unit, wherein the second value is less than the first value.

8. A method for transmitting system information, performed by a network device, and comprising:
transmitting updated system information to a user equipment,
wherein the updated system information is configured to cause the user equipment to determine effective time for the updated system information, and to start to apply the updated system information at the effective time.

9. The method of claim 8, wherein the updated system information comprises an updated cell-specific offset.

10. The method of claim 8, wherein the method further comprises: transmitting a high-level signaling to the user equipment, wherein the high-level signaling comprises configuration information for indicating the effective time, and the effective time for the updated system information is determined based on the configuration information; or
wherein the updated system information comprises an updated cell-specific offset, and the updated system information is configured to cause the user equipment to determine effective time for the updated cell-specific offset, and to start to apply the updated cell-specific offset at the effective time, wherein the method further comprises: transmitting a high-level signaling to the user equipment, wherein the high-level signaling comprises configuration information for indicating the effective time, and the effective time for the updated cell-specific offset is determined based on the configuration information.

11. The method of claim 8, wherein
the effective time corresponds to an end position of a system information window in which the updated system information is located, or
the effective time corresponds to an end position of a modification period for the system information.

12.-35. (canceled)

36. A communication device, comprising:
a processor; and
a memory, wherein
the memory is configured to store computer programs; and
the computer programs, when executed by the processor, cause the processor to perform:
receiving updated system information;
determining effective time for the updated system information; and
starting to apply the updated system information at the effective time.

37. A communication device, comprising:
a processor; and
a memory, wherein
the memory is configured to store computer programs; and
the computer programs, when executed by the processor, cause the processor to perform the method of claim 8.

38. A non-transitory computer-readable storage medium, storing instructions thereon, wherein the instructions, when executed by a processor, cause the processor to perform the method of claim 1.

39. A non-transitory computer-readable storage medium, storing instructions thereon, wherein the instructions, when executed by a processor, cause the processor to perform the method of claim 8.

40. The communication device of claim 36, wherein the updated system information comprises an updated cell-specific offset.

41. The communication device of claim 36, wherein the determining the effective time for the updated system information comprises: receiving a high-level signaling transmitted by a network device, wherein the high-level signaling comprises configuration information for indicating the effective time; and determining, based on the configuration information, the effective time for the updated system information; or
wherein the updated system information comprises an updated cell-specific offset, and the determining the effective time for the updated system information and the starting to apply the updated system information at the effective time comprise: determining effective time for the updated cell-specific offset; and starting to apply the updated cell-specific offset at the effective time, wherein the determining effective time for the updated cell-specific offset comprises: receiving a high-level signaling transmitted by a network device, wherein the high-level signaling comprises configuration information for indicating the effective time; determining, based on the configuration information, the effective time for the updated cell-specific offset.

42. The communication device of claim 36, wherein the determining the effective time for the updated system information comprises: determining, based on a predefined mode in a protocol, the effective time for the updated system information; or
wherein the updated system information comprises an updated cell-specific offset, and the determining the effective time for the updated system information and the starting to apply the updated system information at the effective time comprise: determining effective time for the updated cell-specific offset; and starting to apply the updated cell-specific offset at the effective time, wherein the determining effective time for the updated cell-specific offset comprises: determining, based on a predefined mode in a protocol, the effective time for the updated cell-specific offset.

43. The communication device of claim 36, wherein
the effective time corresponds to an end position of a system information window in which the updated system information is located, or
the effective time corresponds to an end position of a modification period for the system information.

44. The communication device of claim 36, wherein the computer programs further cause the processor to: determine, based on the updated system information, that a conflict occurs in data transmission on a target transmission unit; and perform the data transmission based on a predefined rule; or
wherein the updated system information comprises an updated cell-specific offset, and the computer programs further cause the processor to: determine, based on the updated cell-specific offset, that a conflict occurs in data transmission on a target transmission unit; and perform the data transmission based on a predefined rule.
